(19) United States
(12) Patent Application Publication
(10) Pub. No.: US 2019/0353212 A1
(43) Pub. Date: Nov. 21, 2019

(54) CONCENTRIC BI-STABLE FRONT AXLE DISCONNECT

(71) Applicant: BorgWarner Inc., Auburn Hills, MI (US)

(72) Inventors: Larry A. Pritchard, Macomb, MI (US); Joseph D. Mastie, Belleville, MI (US)

(21) Appl. No.: 15/983,458

(22) Filed: May 18, 2018

(51) Int. Cl. F16D 27/118; F16D 27/00; F16D 11/14

(52) U.S. Cl. CPC F16D 27/118; B60K 17/34; F16D 11/14; F16D 27/004

(57) ABSTRACT

A number of variations may include a product comprising an axle shaft and an input shaft, wherein the axle shaft is coaxial with the input shaft; a clutch operatively connected to the axle shaft and the input shaft constructed and arranged to selectively couple and decouple the input shaft and the axle shaft; and a ring-shaped moving magnet actuator operatively connected to the clutch to drive the clutch.

### TECHNICAL FIELD

The field to which the disclosure generally relates to includes vehicle powertrains.

### BACKGROUND

A vehicle may include at least one driveline which may drive the vehicle.

### SUMMARY OF ILLUSTRATIVE VARIATIONS

A number of variations may include a product comprising: an axle shaft and an input shaft, wherein the axle shaft is coaxial with the input shaft; a clutch operatively connected to the axle shaft and the input shaft constructed and arranged to selectively couple and decouple the input shaft and the axle shaft; and a ring-shaped moving magnet actuator coaxial with the axle shaft and the input shaft, wherein the ring-shaped moving magnet actuator is operatively connected to the clutch to drive the clutch.

A number of variations may include an axle disconnect assembly for translating rotational torque between an input shaft and an axle shaft comprising: a dog clutch, having a sleeve operatively connected to the axle shaft and a coupling member operatively connected to the input shaft, constructed and arranged to selectively couple and decouple the input shaft and the axle shaft; an actuator operatively connected to and surrounding at least a portion of the dog clutch constructed and arranged to drive the dog clutch, wherein the actuator comprises a ring-shaped magnet having a first side and an opposite second side, a first coil adjacent the first side, and a second coil adjacent the second side, and wherein the ring-shaped magnet is constructed and arranged to move axially between a first position and a second position; wherein the first coil and the second coil are constructed and arranged to operate in unison to axially move the magnet from the first position to the second position using inductance; and wherein the ring-shaped magnet is secured to the sleeve of the dog clutch and is constructed and arranged to drive the sleeve.

A number of variations may include a method of selectively coupling and decoupling a front axle comprising: providing a clutch between an input shaft and an axle shaft to selectively couple and decouple the input shaft and the axle shaft; actuating the clutch using a ring-shaped moving magnet actuator, wherein the ring-shaped moving magnet actuator comprises a ring-shaped magnet, a first coil adjacent a first side of the ring-shaped magnet, and a second coil adjacent a second side of the ring-shaped magnet; and flowing a current through the first coil to generate a first magnetic field and flowing a current through the second coil to generate a second magnetic field to selectively move the ring-shaped magnet to a first position causing the clutch to move to a disengaged position and changing a direction of the flow of the current through the first coil and the second coil to reverse the first magnetic field and the second magnetic field to selectively move the ring-shaped magnet to a second position causing the clutch to move to a disengaged position.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a vehicle schematic according to a number of variations.

FIG. 2 illustrates a section view of a front axle disconnect according to a number of variations.

### DETAILED DESCRIPTION OF ILLUSTRATIVE VARIATIONS

The following description of the variations is merely illustrative in nature and is in no way intended to limit the scope of the invention, its application, or uses.

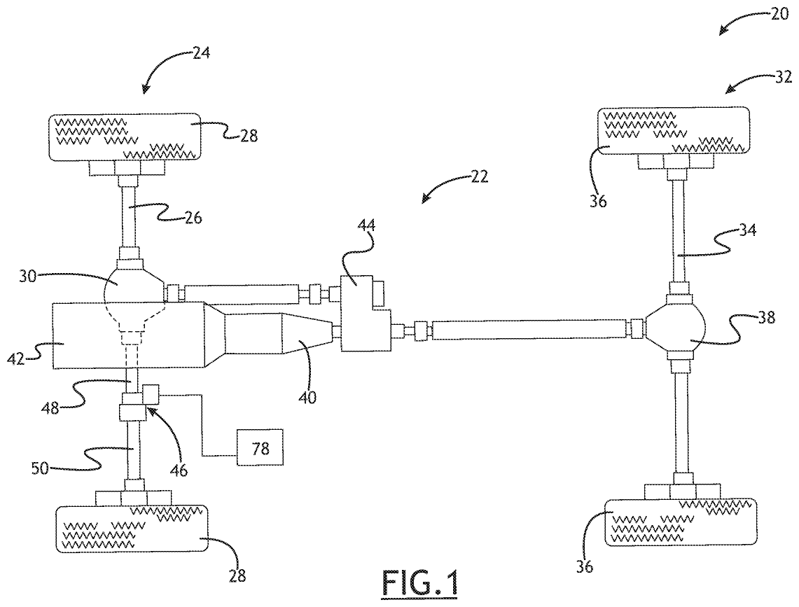

Referring to FIG. 1, in a number of variations, a four-wheel drive or all-wheel drive vehicle 20 may include a powertrain 22, which may include a first driveline 24 and a second driveline 32. The first driveline 24 may include a first drive shaft 26, which may drive a first set of wheels 28, and the second driveline 32 may include a second drive shaft 34, which may drive a second set of wheels 36. A transmission 40 may be operatively connected to the first and second drivelines 24, 32. The transmission 40 may generate and deliver torque from an engine 42 including, but not limited to, an internal combustion engine, to the first and second drivelines 24, 32. A transfer case 44 may be operatively connected to the transmission 40 and may split rotational torque between the first and second drivelines 24, 32. The first driveline 24 may include a first differential 30, which may be constructed and arranged to receive rotational torque from the transfer case 44 and may split the rotational torque between the first set of wheels 28. In a number of variations, the second driveline 32 may include a second differential 38, which may be constructed and arranged to receive rotational torque from the transfer case 44 and may split the rotational torque between the second set of wheels 36. At least one axle disconnect assembly 46 may be operatively attached to the first or the second driveline 24, 32. In a number of variations, the axle disconnect assembly 46 may selectively disconnect the first or second driveline 24, 32 from rotational communication with the transmission 40, transfer case 44, and the first or second differential 30, 38. An axle disconnect assembly 46 may minimize parasitic loss by eliminating unnecessary rotation and/or torque translation, which may increase the efficiency of the powertrain system when the four-wheel drive or all-wheel drive vehicle 20 is operating in a two-wheel drive mode.

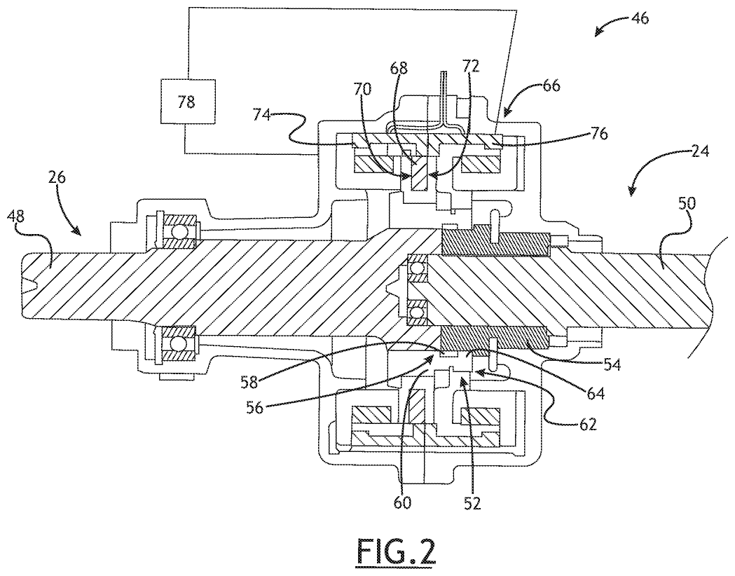

Referring to FIG. 2, in a number of variations, the axle disconnect assembly 46 may be operatively connected to the first driveline 24 (as illustrated in FIG. 1) or the second driveline 32. In a number of variations, the first drive shaft 26 of the first driveline 24 or the second driveshaft 34 of the second driveline 32 may include an axle shaft 48 and an input shaft 50, which may be coaxial with the axle shaft 48. In a number of variations, a clutch assembly 52 may be operatively connected to the axle shaft 48 and the input shaft 50 and may be constructed and arranged to selectively couple and decouple the axle shaft 48 and the input shaft 50 upon actuation by an actuator assembly 66. When the axle shaft 48 and the input shaft 50 are coupled together, rotational torque may be translated between the axle shaft 48 and the input shaft 50. When the axle shaft 48 and the input shaft 50 are not coupled together, rotational torque may be interrupted between the axle shaft 48 and the input shaft 50. Any number of clutch assemblies 52 may be used including, but not limited to, dog clutches.

In a number of variations, a clutch assembly 52 may include a coupling member 54, which may be operatively connected to the input shaft 50 so that it may rotate with the input shaft 50, and a clutch sleeve 60 which may be attached to the axle shaft 48 through a splined connected so that the clutch sleeve 60 may rotate with the axle shaft 48 and may also move axially along the axle shaft 48. The coupling member 54 may include a first end 56 that may comprise a plurality of teeth 58. The clutch sleeve 60 may also include a first end 62 that may comprise a plurality of teeth 64, which may be constructed and arranged to selectively engage the plurality of teeth 58 on the coupling member 54. In a number of variations, the plurality of teeth 64 on the clutch sleeve 60 may engage the plurality of teeth 58 of the coupling member 54 when the clutch sleeve 60 is moved axially along the axle shaft 48 from a first disengaged position to a second engaged position. When the plurality of teeth 64 on the clutch sleeve 60 are engaged with the plurality of teeth 58 on the coupling member 54, the axle shaft 48 and the input shaft 50 may be coupled together so that they may rotate together allowing the vehicle 20 to operate in four-wheel drive or all-wheel drive. When the plurality of teeth 64 on the clutch sleeve 60 are disengaged with the plurality of teeth 58 on the coupling member 54, rotational torque between the axle shaft 48 and the input shaft 50 may be interrupted allowing the vehicle 20 to operate in a two-wheel drive mode.

In a number of variations, an actuator assembly 66 may be operatively attached to the clutch sleeve 60 to drive the clutch sleeve 60 axially between the first disengaged position and the second engaged position. The actuator assembly 66 may be coaxial with the axle shaft 48 and the input shaft 50 and may surround at least a portion of the clutch assembly 52. The actuator assembly 66 may comprise a ring-shaped moving magnet actuator that may be axially polarized to move the permanent magnet 68 between a first stable position and a second stable position. The actuator assembly 66 may include a permanent magnet 68 having a first side 70 and a second side 72, a first coil 74 adjacent the first side 70, and a second coil 76 adjacent the second side 72. In a number of variations, the permanent magnet 68 may be ring-shaped or annular. In a number of variations, the first coil 74 and the second coil 76 may also be ring-shaped or annular.

In a number of variations, the actuator assembly 66 may be bi-stable so that the actuator assembly 66 holds the clutch sleeve 60 in the first disengaged position or the second engaged position without the need to continuously energize the first coil 74 and/or the second coil 76. In a number of variations, the first coil 74 may selectively generate a first magnetic field and the second coil 76 may selectively generate a second magnetic field. The permanent magnet 68 may be selectively drawn to the first stable position adjacent the first coil 74 causing the clutch sleeve 60 to be disengaged from the coupling member 54, or to the second stable position adjacent the second coil 76, causing the clutch sleeve 60 to engage with the coupling member 54. The permanent magnet 68 may be held in the first stable position or the second stable position through the magnetic force of the permanent magnet 68. The permanent magnet 68 may be moved out of the holding force of one of the stable positions to the other stable position through inductance by changing a flow of current through the first coil 74 and the second coil 76 to reverse the first magnetic field and the second magnetic field, where a phase shift occurs between the first disengaged position of the clutch assembly 52 and the second engaged position of the clutch assembly 52.

In a number of variations, a controller 78 may be in electrical communication with the first coil 74 and the second coil 76 to selectively generate and/or reverse the polarity of the first and the second magnetic fields to move the magnet 68 to either the first stable position or the second stable position. In a number of variations, the controller 78 may be constructed and arranged to direct an electrical charge through the first coil 74 and the second coil 76 so that the first magnetic field and the second magnetic field are induced by the flow of electrical charges in the first coil 74 and the second coil 76. A change in the direction of the flow of electrical charges in the first coil 74 and the second coil 76 may cause a corresponding reversal of the generated magnetic fields causing the magnet 68 to move axially from one stable position to the other. The controller 78 may be constructed and arranged to selectively flow current or reverse current flow through each of the first coil 74 and the second coil 76 independently or simultaneously. Further, the first coil 74 and the second coil 76 may be wound in opposite directions or in the same direction.

Any number of controllers may be used. Methods, algorithms, or parts thereof may be implemented in a computer program incorporated into the controller 78 including instructions or calculations carried on a computer readable medium for use by one or more processors to implement one or more steps or instructions. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program may be executed on one processor or on multiple processors in communication with one another. In a number of variations, the program(s) may be embodied on computer readable media, which may include one or more storage devices, articles of manufacture, or the like. Illustrative computer readable media may include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium also may include computer to computer connections, for example, when data may be transferred or provided over a network or another communications connection (either wired, wireless, or a combination thereof). Any combination(s) of the above examples is also included within the scope of the computer-readable media. It is therefore to be understood that methods may be at least partially performed by any electronic articles and/or devices capable of executing instructions corresponding to one or more steps of the disclosed methods.

In a number of variations, the above actuator assembly 66 may provide for improved performance, reduced mass, and improved packaging due to the concentric arrangement of the actuator assembly 66 to the input shaft 50 and the axle shaft 48. Further, the above configuration of the actuator assembly 66 may reduce costs as less components may be required to actuate the clutch assembly 52.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: an axle shaft and an input shaft, wherein the axle shaft is coaxial with the input shaft; a clutch operatively connected to the axle shaft and the input shaft constructed and arranged to selectively couple and decouple the input shaft and the axle shaft; and a ring-shaped moving magnet actuator coaxial with the axle shaft and the input shaft, wherein the ring-shaped moving magnet actuator is operatively connected to the clutch to drive the clutch.

Variation 2 may include a product as set forth in Variation 1, wherein the ring-shaped moving magnet actuator comprises a ring-shaped magnet having a first side and an opposite second side, a first coil adjacent the first side, and a second coil adjacent the second side; and wherein the first coil and the second coil are constructed and arranged to move the ring-shaped magnet between a first position and a second position through inductance.

Variation 3 may include a product as set forth in Variation 2, wherein the clutch comprises a coupling member and a sleeve constructed and arranged to selectively engage with the coupling member, wherein the coupling member is operatively attached to the input shaft to rotate with the input shaft, and the sleeve is operatively attached to the axle shaft to rotate with the axle shaft and move axially along the axle shaft, and wherein the ring-shaped magnet is secured to the sleeve and constructed and arranged to selectively drive the sleeve to engage or disengage the coupling member.

Variation 4 may include a product as set forth in any of Variations 2-3, wherein the ring-shaped magnet is attached to the clutch so that when the ring-shaped magnet is in the first position, the clutch is disengaged so that the axle shaft and the input shaft are not coupled together and when the ring-shaped magnet is in the second position the clutch is engaged so that the axle shaft and the input shaft are coupled together.

Variation 5 may include a product as set forth in any of Variations 1-4, wherein the ring-shaped moving magnet actuator is bi-stable.

Variation 6 may include a product as set forth in any of Variations 1-5, wherein the clutch is a dog clutch.

Variation 7 may include an axle disconnect assembly for translating rotational torque between an input shaft and an axle shaft comprising: a dog clutch having a sleeve operatively connected to the axle shaft and a coupling member operatively connected to the input shaft, constructed and arranged to selectively couple and decouple the input shaft and the axle shaft; an actuator operatively connected to and surrounding at least a portion of the dog clutch constructed and arranged to drive the dog clutch, wherein the actuator comprises a ring-shaped magnet having a first side and an opposite second side, a first coil adjacent the first side, and a second coil adjacent the second side, and wherein the ring-shaped magnet is constructed and arranged to move axially between a first position and a second position using inductance; wherein the first coil and the second coil are constructed and arranged to operate in unison to axially move the magnet from the first position to the second position; and wherein the ring-shaped magnet is secured to the sleeve of the dog clutch and is constructed and arranged to drive the sleeve.

Variation 8 may include an axle disconnect assembly as set forth in Variation 7, wherein when the ring-shaped magnet is in the first position, the axle shaft and the input shaft are decoupled and when the magnet is in the second position, the axle shaft and the input shaft are coupled together.

Variation 9 may include an axle disconnect assembly as set forth in any of Variations 7-8, wherein the actuator is coaxial with the input shaft and the axle shaft.

Variation 10 may include an axle disconnect assembly as set forth in any of Variations 7-9, wherein the actuator is bi-stable.

Variation 11 may include a method of selectively coupling and decoupling a front axle comprising: providing a clutch between an input shaft and an axle shaft to selectively couple and decouple the input shaft and the axle shaft; actuating the clutch using a ring-shaped moving magnet actuator, wherein the ring-shaped moving magnet actuator comprises a ring-shaped magnet, a first coil adjacent a first side of the ring-shaped magnet, and a second coil adjacent a second side of the ring-shaped magnet; and flowing a current through the first coil to generate a first magnetic field and flowing a current through the second coil to generate a second magnetic field to selectively move the ring-shaped magnet to a first position causing the clutch to move to a disengaged position and changing a direction of the flow of the current through the first coil and the second coil to reverse the first magnetic field and the second magnetic field to selectively move the ring-shaped magnet to a second position causing the clutch to move to a disengaged position.

Variation 12 may include a method as set forth in Variation 11, wherein the ring-shaped moving magnet is coaxial with the input shaft and the axle shaft.

Variation 13 may include a method as set forth in any of Variations 11-12, wherein the clutch is directly secured to the ring-shaped magnet.

Variation 14 may include a method as set forth in any of Variations 11-13, wherein the clutch is a dog clutch.

Variation 15 may include a method as set forth in any of Variations 11-14, wherein the ring-shaped moving magnet actuator is bi-stable.

The above description of select variations within the scope of the invention is merely illustrative in nature and, thus, variations or variants thereof are not to be regarded as a departure from the spirit and scope of the invention.

What is claimed is:

1. A product comprising:
an axle shaft and an input shaft, wherein the axle shaft is coaxial with the input shaft;
a clutch operatively connected to the axle shaft and the input shaft constructed and arranged to selectively couple and decouple the input shaft and the axle shaft; and
a ring-shaped moving magnet actuator coaxial with the axle shaft and the input shaft, wherein the ring-shaped moving magnet actuator is operatively connected to the clutch to drive the clutch.

2. The product of claim 1, wherein the ring-shaped moving magnet actuator comprises a ring-shaped magnet having a first side and an opposite second side, a first coil adjacent the first side, and a second coil adjacent the second side; and wherein the first coil and the second coil are constructed and arranged to move the ring-shaped magnet between a first position and a second position through inductance.

3. The product of claim 2, wherein the clutch comprises a coupling member and a sleeve constructed and arranged to selectively engage with the coupling member, wherein the coupling member is operatively attached to the input shaft to rotate with the input shaft, and the sleeve is operatively attached to the axle shaft to rotate with the axle shaft and move axially along the axle shaft, and wherein the ring-shaped magnet is secured to the sleeve and constructed and arranged to selectively drive the sleeve to engage or disengage the coupling member.

4. The product of claim 2, wherein the ring-shaped magnet is attached to the clutch so that when the ring-shaped magnet is in the first position, the clutch is disengaged so that the axle shaft and the input shaft are not coupled together and when the ring-shaped magnet is in the second position the clutch is engaged so that the axle shaft and the input shaft are coupled together.

5. The product of claim 1, wherein the ring-shaped moving magnet actuator is bi-stable.

6. The product of claim 1, wherein the clutch is a dog clutch.

7. An axle disconnect assembly for translating rotational torque between an input shaft and an axle shaft comprising:
a dog clutch, having a sleeve operatively connected to the axle shaft and a coupling member operatively connected to the input shaft, constructed and arranged to selectively couple and decouple the input shaft and the axle shaft;
an actuator operatively connected to and surrounding at least a portion of the dog clutch constructed and arranged to drive the dog clutch, wherein the actuator comprises a ring-shaped magnet having a first side and an opposite second side, a first coil adjacent the first side, and a second coil adjacent the second side, and wherein the ring-shaped magnet is constructed and arranged to move axially between a first position and a second position;
wherein the first coil and the second coil are constructed and arranged to operate in unison to axially move the magnet from the first position to the second position using inductance; and
wherein the ring-shaped magnet is secured to the sleeve of the dog clutch and is constructed and arranged to drive the sleeve.

8. The axle disconnect assembly of claim 7, wherein when the ring-shaped magnet is in the first position, the axle shaft and the input shaft are decoupled and when the magnet is in the second position, the axle shaft and the input shaft are coupled together.

9. The axle disconnect assembly of claim 7, wherein the actuator is coaxial with the input shaft and the axle shaft.

10. The axle disconnect assembly of claim 7, wherein the actuator is bi-stable.

11. A method of selectively coupling and decoupling a front axle comprising:
providing a clutch between an input shaft and an axle shaft to selectively couple and decouple the input shaft and the axle shaft;
actuating the clutch using a ring-shaped moving magnet actuator, wherein the ring-shaped moving magnet actuator comprises a ring-shaped magnet, a first coil adjacent a first side of the ring-shaped magnet, and a second coil adjacent a second side of the ring-shaped magnet; and
flowing a current through the first coil to generate a first magnetic field and flowing a current through the second coil to generate a second magnetic field to selectively move the ring-shaped magnet to a first position causing the clutch to move to a disengaged position and changing a direction of the flow of the current through the first coil and the second coil to reverse the first magnetic field and the second magnetic field to selectively move the ring-shaped magnet to a second position causing the clutch to move to a disengaged position.

12. The method of claim 11, wherein the ring-shaped moving magnet is coaxial with the input shaft and the axle shaft.

13. The method of claim 11, wherein the clutch is directly secured to the ring-shaped magnet.

14. The method of claim 11, wherein the clutch is a dog clutch.

15. The method of claim 11, wherein the ring-shaped moving magnet actuator is bi-stable.
